(19) United States
(12) Patent Application Publication
(10) Pub. No.: US 2010/0188178 A1
(43) Pub. Date: Jul. 29, 2010

(54) MAGNETIC WATERPROOF SWITCH ASSEMBLY

(76) Inventor: Min-Chin Chen, Kaohsiung Hsien (TW)

Correspondence Address: Hershkovitz & Associates, LLC, 2845 Duke Street, Alexandria, VA, 22314, US

(21) Appl. No.: 12/669,479

(22) PCT Filed: Jul. 24, 2007
(86) PCT No.: PCT/CN07/02246

§ 371 Date: Jan. 15, 2010

(51) Int. Cl. H01H 9/04

(52) U.S. Cl. 335/205

(57) ABSTRACT

A magnetic waterproof switch assembly comprises a waterproof housing. A base, an iron sheet and a switch are set in the waterproof housing. An entrance of the waterproof housing is tightly sealed by a waterproof cover and is filled with a waterproof glue. A magnet controlling component is positioned outside the waterproof housing.

### BACKGROUND OF THE INVENTION

1. Field of the Invention

The present invention relates to the field of switches, and more particularly to a magnetic waterproof switch assembly with simply fabricated structure to facilitate manufacture thereof.

2. Description of Related Art

Waterproof switches prevent water from causing shorting problems. In the prior art, Taiwan utility patent application No. 92218727, titled “magnetically attractive waterproof switch”, discloses a waterproof switch. The waterproof switch has a casing mounted outside an electronic device. The electronic device has components such as a printed circuit board, a light emitting diode, a battery and a vibration switch. The printed circuit board has a crossover cable having two separate contacts. A movable metal piece is located opposite to the separate contacts. When the metal piece is separated from the contacts, a circuit of the electronic device is broken. When the metal piece contacts both the contacts, the circuit is activated.

The aforementioned waterproof design provides a waterproof switch. However, the magnetically attractive waterproof switch uses an ultrasonic wave welded and sealed casing to enclose the electronic device. The waterproof effect of such structure is insufficient. Furthermore, the metal piece controlling the switch cannot precisely activate the switch. When the metal piece is inclined or shifts when raised or dropped, the metal piece does not contact both the contacts, which negatively affects the function of the waterproof switch.

In the prior art, China utility patent No. CN2472328Y titled “waterproof button switch” comprises a bottom and a cover to form a button switch housing. An outer edge of the bottom has a rectangular sidewall. The cover is a rectangular enclosure and has an annular rib formed on an inner surface thereof. A size of an inner edge of the cover corresponds to a size of the outer edge to prevent moisture from entering the cover through sides of the cover. Waterproof button switch is formed by mechanical structures of a mounting tab, a spring, a forked tab and terminals. Such mechanical structure has many components so material and manufacturing costs thereof are high, so reducing market competitiveness.

China utility patent No. CN2502394Y titled “sealed On/Off controller driven by variation of magnetic field” comprises a casing having a sealed chamber defined therein. A press shaft is mounted on an outside of the casing and cooperates with a recoiling spring. A dynamic alteration tab and a static alteration tab are mounted in the sealed chamber. The dynamic alteration tab is connected to a permanent magnet. However, fatigue of the dynamic alteration tab is caused by repeated bends by magnetic attraction leading to permanent deformation.

### SUMMARY OF THE INVENTION

The main objective of the invention is to provide a magnetic waterproof switch assembly that comprises a waterproof housing, a bottom base, an iron sheet and a switch mounted in the waterproof housing, a cover covering an entrance of the waterproof housing and a waterproof glue filled on the outside end of the waterproof housing to form a sealed waterproof structure to provide excellent waterproof effects. The switch and iron sheet in the waterproof housing drive a magnet controlling element to move toward or away from the iron sheet so that the iron sheet is attracted to press or release a button. The simple structural design of the present invention lowers costs and improves competitiveness thereof.

To achieve the aforementioned structure characteristics and technologies, the “magnetic waterproof switch assembly” in accordance with the present invention comprises:

a waterproof housing, wherein a chamber is defined therein, an entrance defined in one end of the waterproof housing;

a bottom base mounted in the waterproof housing, wherein a side plate 11 is formed on one side of the bottom base;

a switch having a button mounted on the bottom base, wherein a cable is connected electrically to the button;

an iron sheet mounted on the bottom base and located adjacent to the button of the switch;

a waterproof cover covering the entrance of the waterproof housing;

a waterproof glue sealing the entrance of the water casing; and

a magnet controlling element mounted on an outside of the waterproof housing near the iron sheet, wherein a magnet is mounted on one end thereof near the iron sheet.

The aforementioned design provides a fully sealed waterproof structure to achieve excellent waterproof effects. Furthermore, the simple structure formed by the switch and iron sheet mounted the waterproof housing allows attraction or separation of the magnet controlling element and the iron sheet to drive the iron sheet to press or release the button. Therefore, manufacturing and fabricating the magnetic waterproof switch assembly of the present invention is easy, which achieves goals of lowering cost and improving competitiveness.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment in accordance with the present invention;

FIG. 2 is a perspective view of the first embodiment in accordance with the present invention;

FIG. 3 is a first operational view of the first embodiment in accordance with the present invention;

FIG. 4 is a second operational view of the first embodiment in accordance with the present invention;

FIG. 5 is an exploded perspective view of a second embodiment in accordance with the present invention;

FIG. 6 is a perspective view of the second embodiment in accordance with the present invention;

FIG. 7 is a front view of the second embodiment in accordance with the present invention;

FIG. 8 is an end view in partial section of the second embodiment in accordance with the present invention;

FIG. 9 is a first operational view of the second embodiment in accordance with the present invention; and

FIG. 10 is a second operational view of the second embodiment in accordance with the present invention.

### DETAILED DESCRIPTION OF THE PREFERRED EMBODIMENT

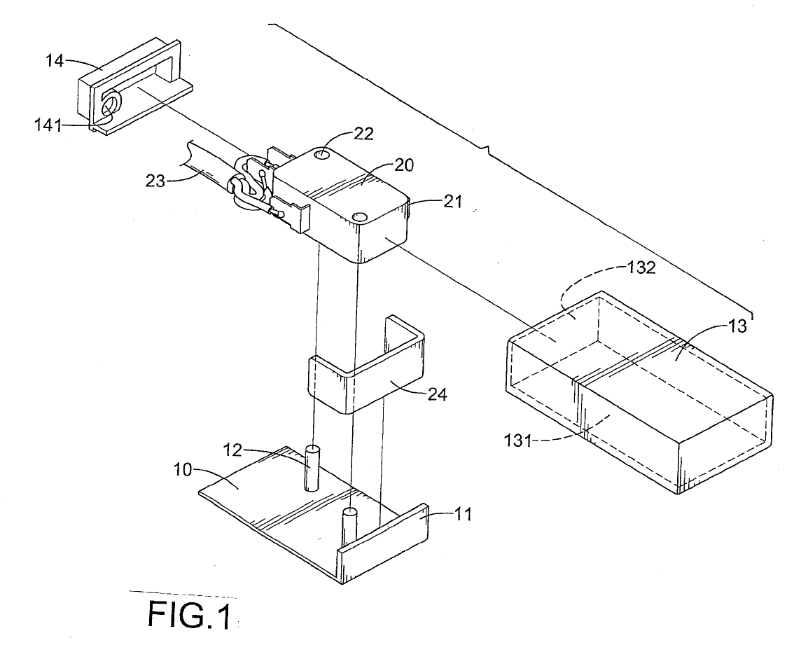

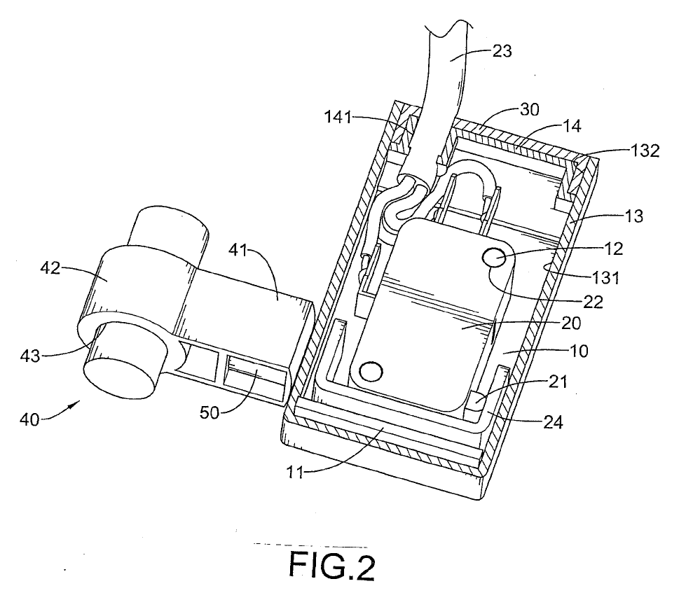

With reference to FIGS. 1 to 4, a first embodiment of a magnetic waterproof switch assembly in accordance with the present invention comprises:

a waterproof housing 13, wherein a chamber 131 is defined therein, an entrance 132 defined in one end of the waterproof housing 13;

a bottom base 10 mounted in the waterproof housing 13, wherein a side plate 11 is formed on one side of the bottom base 10;

a switch 20 having a button 21 mounted on the bottom base 10, wherein a cable 23 is connected electrically to the button 20;

an iron sheet 24 mounted on the bottom base 10 and located adjacent to the button 21 of the switch 20;

a waterproof cover 14 covering the entrance 132 of the waterproof housing 132;

a waterproof glue 30 sealing the entrance 132 of the water casing 132; and

a magnet controlling element 40 positioned outside the waterproof housing 13 near the iron sheet 24, wherein a magnet 50 is mounted on one end thereof near the iron sheet 24.

The switch 20 may be a limit switch or other type of switch. Multiple contacts, including a ground contact, a live contact and a neutral contact, are mounted on the switch 20. The cable 23 has a ground wire, a live wire and a neutral wire soldered respectively on the contacts to form an electrical connection. When the button 21 is pressed, the switch assembly is activated or deactivated to make or break a circuit formed by the ground wire and live wire.

The waterproof cover 14 has a through hole 141 so that the cable 23 may extend out through the through hole 141.

Multiple positioning holes 22 are defined in the switch 20. Multiple positioning posts 12 are formed on the bottom base 10 and correspond to the positioning holes 22. The positioning posts 12 may be mounted respectively in the positioning holes 22 to mount the switch 20 on the bottom base 10.

The iron sheet 24 may be magnetic inductive material, is U-shaped, is located adjacent to the button 21 of the switch 20 and selectively moves to contact the button 21.

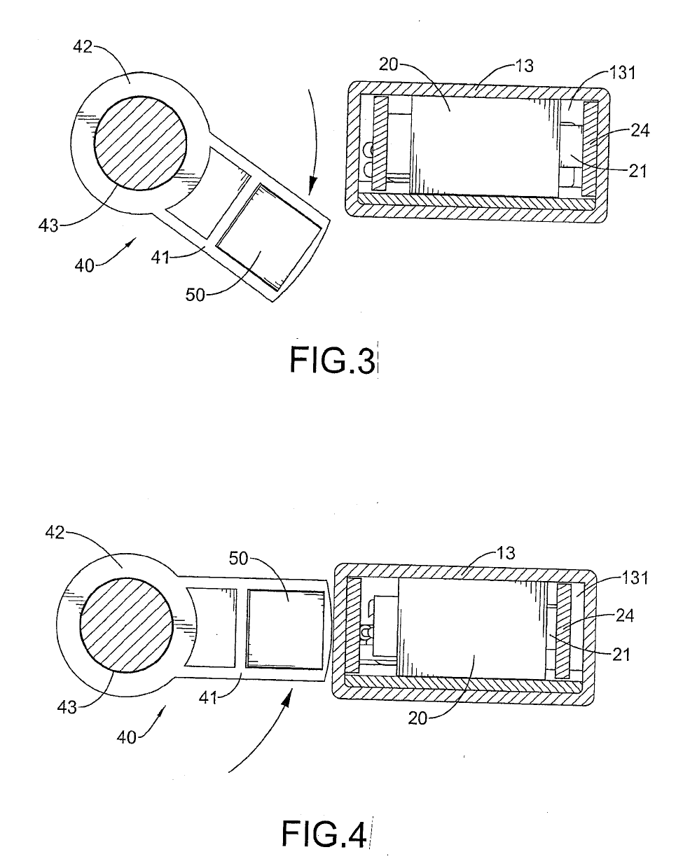

The magnet controlling element 40 has a positioning bracket 41 and a mounting bracket 42. The magnet 50 is mounted in the positioning bracket 41. A through hole 43 is defined through the mounting bracket 42. The mounting bracket 42 may be connected to a switch control device so that the magnet controlling element 40 may be driven to rotate or move. In the first embodiment, the magnet controlling element 40 is controlled by rotation. The through hole 43 of the mounting bracket 42 may be mounted rotatably around a shaft of the switch control device so that the magnet controlling element 40 may be driven to move near the iron sheet 24 to attract or repel the iron sheet 24. FIG. 3 shows that the magnet 50 is located far away from and cannot attract the iron sheet 24. FIG. 4 shows that the magnet controlling element 40 rotates to move the magnet 50 the iron sheet 24 to attract the iron sheet 24 to move. Therefore, one side of the attracted magnet 50 presses the button 21 to turn the switch 20 on/off.

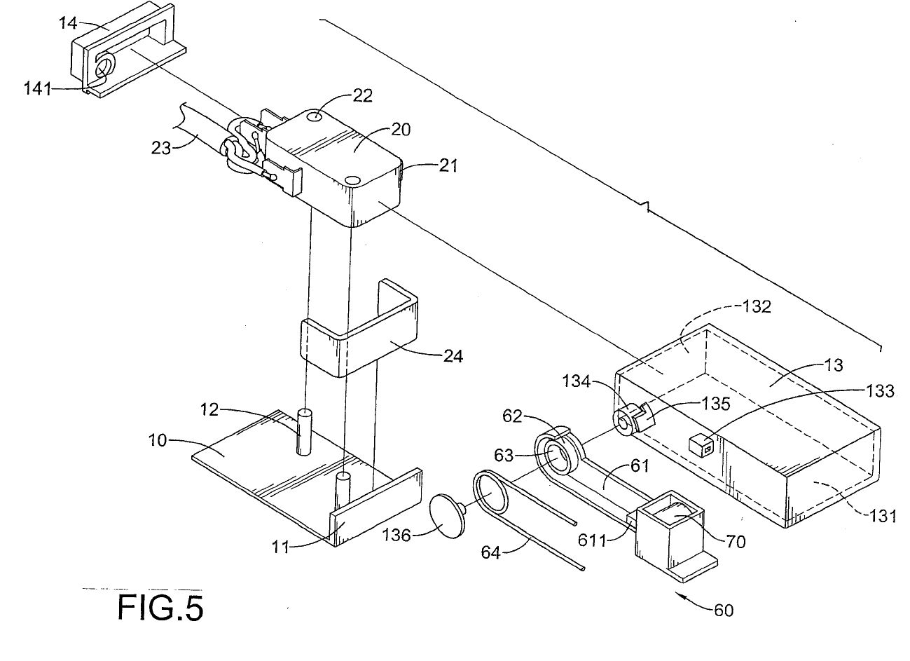

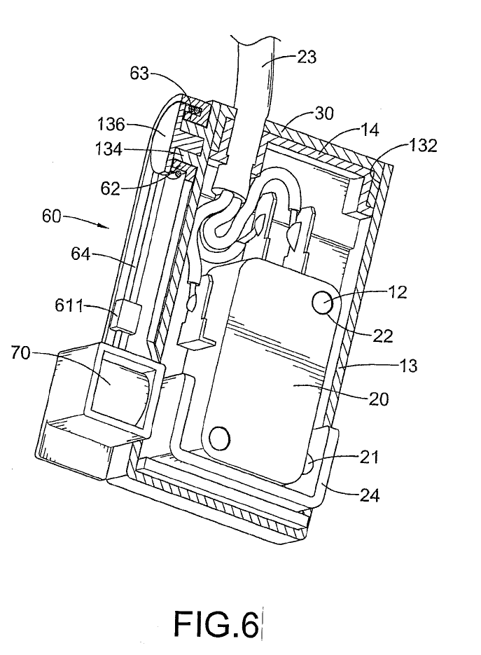

With further reference to FIGS. 5 to 10, a second embodiment of the magnetic waterproof switch assembly comprises:

a waterproof housing 13, wherein a chamber 131 is defined therein, an entrance 132 defined in one end of the waterproof housing 13;

a bottom base 10 mounted in the waterproof housing 13, wherein a side plate 11 is formed on one side of the bottom base 10;

a switch 20 having a button 21 mounted on the bottom base 10, wherein a cable 23 is connected electrically to the button 20;

an iron sheet 24 mounted on the bottom base 10 and located adjacent to the button 21 of the switch 20;

a waterproof cover 14 covering the entrance 132 of the waterproof housing 132;

a waterproof glue 30 sealing the entrance 132 of the water casing 132; and

a magnet controlling element 60 positioned outside the waterproof housing 13 near the iron sheet 24, wherein a magnet 70 is mounted on one end thereof near the iron sheet 24.

The difference between the first and second embodiments is that the magnet controlling element 60 positioned outside the waterproof housing 13 and has a positioning bracket 61 and a mounting bracket 62. The magnet 70 is mounted in the positioning bracket 61. A pivot pin 134, a limit 135 and a mounting protrusion 133 are mounted on an outside of the waterproof housing 13. A through hole 63 is defined through the mounting bracket 62. The through hole 63 of the mounting bracket 62 is mounted around and fastened on the pivot pin 134 by a fastener 136. A hook 611 is mounted on the positioning bracket 61. A torsion spring 64 is mounted around the mounting bracket 61 and has two ends that one end is hooked by the hook 611 and the other end is mounted on the mounting protrusion 133. Therefore, the magnet controlling element 60 selectively rotates on the outside of the waterproof housing 13.

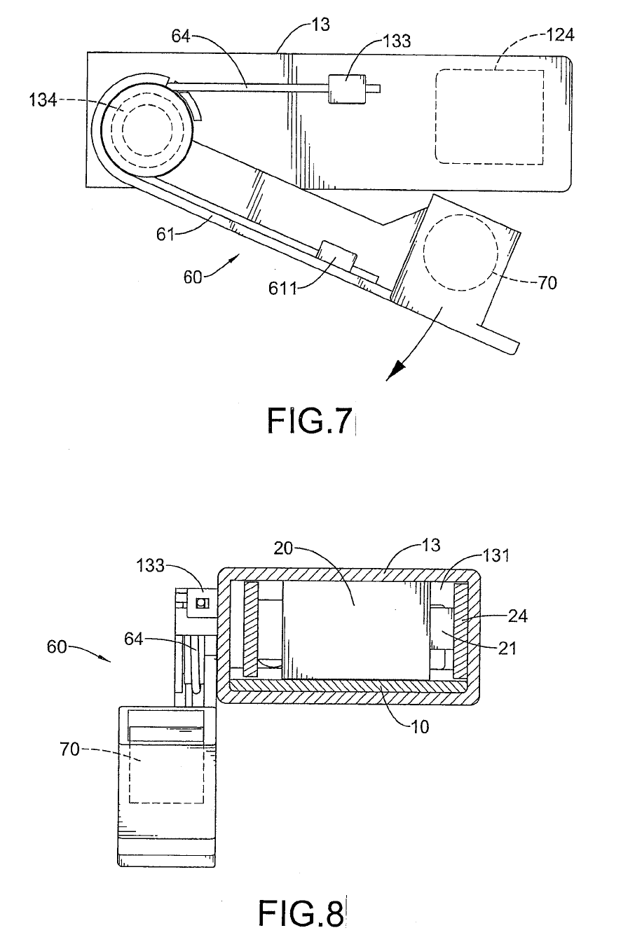

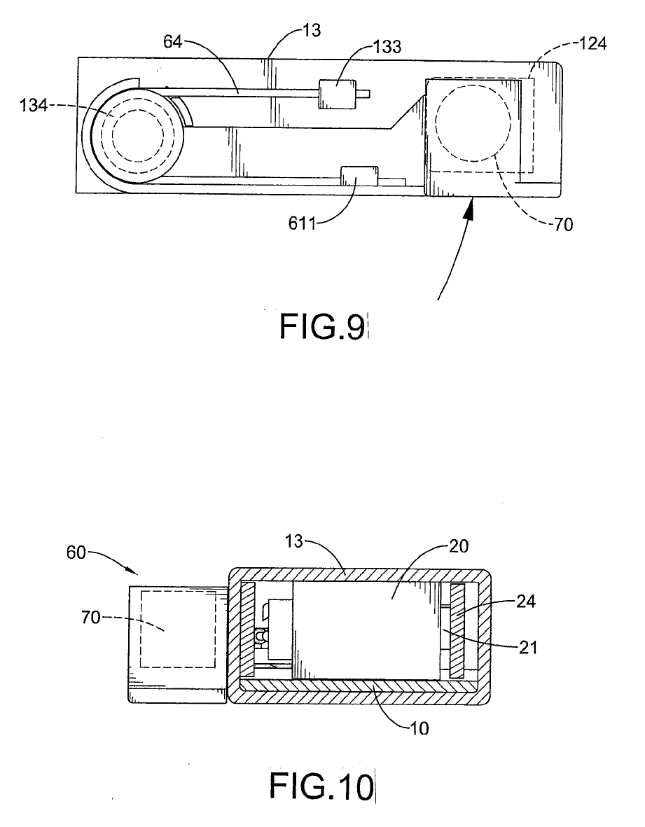

With further reference to FIGS. 7 and 8, the positioning bracket 61 of the magnet controlling element 60 is pivoted down to locate the magnet 70 far away from the iron sheet 24. With further reference to FIGS. 9 and 10, the magnet controlling element 60 is pivot up to move the magnet 70 near the iron sheet 24 so that the iron sheet 24 is attracted and driven to press the button 21 to turn on/off the switch 20.

### INDUSTRIAL APPLICABILITY

According the aforementioned descriptions of structural characteristics, technologies, and operations, it is clear that the present invention has the following advantages:

1. The present invention provides a magnetic waterproof switch assembly that is structurally simple, acts certainly and precisely and provides lager output power by the switch.

2. The present invention provides a simple structure wherein the switch and iron sheet are mounted in the waterproof housing to make the magnetic waterproof switch assembly fabricated easy, lower a manufacturing cost and raise competitiveness.

3. The present invention provides fine waterproof properties. The bottom base, iron sheet and switch are mounted in the waterproof housing, the waterproof cover covers the waterproof housing and the waterproof glue is filled in and seals the waterproof housing. Therefore, the magnetic waterproof switch assembly is watertight to have excellent water-resistant effects.

4. The present invention provides a magnetic waterproof switch assembly that has flexibility for fabrication. The magnet may be mounted out of the waterproof housing or on the outside of the waterproof housing. The present invention may provide various fabrications according to requirements of different controlling or mechanical designs.

1. A magnetic waterproof switch assembly comprising:
a waterproof housing, wherein a chamber is defined therein, an entrance defined in one end of the waterproof housing;
a bottom base mounted in the waterproof housing, wherein a side plate 11 is formed on one side of the bottom base;
a switch having a button mounted on the bottom base, wherein a cable is connected electrically to the button;
an iron sheet mounted on the bottom base and located adjacent to the button of the switch;
a waterproof cover covering the entrance of the waterproof housing;
a waterproof glue sealing the entrance of the water casing; and
a magnet controlling element positioned outside the waterproof housing near the iron sheet, wherein a magnet is mounted on one end thereof near the iron sheet.

2. The magnetic waterproof switch assembly as claimed in claim 1, wherein the waterproof housing has a through hole.

3. The magnetic waterproof switch assembly as claimed in claim 2, wherein the iron sheet is U-shaped.

4. The magnetic waterproof switch assembly as claimed in claim 1 wherein multiple positioning holes are defined in the switch, multiple positioning posts are formed on the bottom base and correspond to the positioning holes, and the positioning posts are mounted respectively in the positioning holes to mount the switch on the bottom base.

5. The magnetic waterproof switch assembly as claimed in claim 4, wherein the magnet controlling element has a positioning bracket and a mounting bracket, the magnet is mounted in the positioning bracket, and a through hole is defined through the mounting bracket.

6. The magnetic waterproof switch assembly as claimed in claim 5, wherein a pivot pin, a limit and a mounting protrusion are mounted on an outside of the waterproof housing, a through hole is defined through the mounting bracket and mounted around and fastened on the pivot pin, a hook is mounted on the positioning bracket, and a torsion spring is mounted around the mounting bracket and has two ends that one end is hooked by the hook and the other end is mounted on the mounting protrusion.

7. The magnetic waterproof switch assembly as claimed in claim 2 wherein multiple positioning holes are defined in the switch, multiple positioning posts are formed on the bottom base and correspond to the positioning holes, and the positioning posts are mounted respectively in the positioning holes to mount the switch on the bottom base.

8. The magnetic waterproof switch assembly as claimed in claim 3 wherein multiple positioning holes are defined in the switch, multiple positioning posts are formed on the bottom base and correspond to the positioning holes, and the positioning posts are mounted respectively in the positioning holes to mount the switch on the bottom base.

9. The magnetic waterproof switch assembly as claimed in claim 7, wherein the magnet controlling element has a positioning bracket and a mounting bracket, the magnet is mounted in the positioning bracket, and a through hole is defined through the mounting bracket.

10. The magnetic waterproof switch assembly as claimed in claim 8, wherein the magnet controlling element has a positioning bracket and a mounting bracket, the magnet is mounted in the positioning bracket, and a through hole is defined through the mounting bracket.

11. The magnetic waterproof switch assembly as claimed in claim 9, wherein a pivot pin, a limit and a mounting protrusion are mounted on an outside of the waterproof housing, a through hole is defined through the mounting bracket and mounted around and fastened on the pivot pin, a hook is mounted on the positioning bracket, and a torsion spring is mounted around the mounting bracket and has two ends that one end is hooked by the hook and the other end is mounted on the mounting protrusion.

12. The magnetic waterproof switch assembly as claimed in claim 10, wherein a pivot pin, a limit and a mounting protrusion are mounted on an outside of the waterproof housing, a through hole is defined through the mounting bracket and mounted around and fastened on the pivot pin, a hook is mounted on the positioning bracket, and a torsion spring is mounted around the mounting bracket and has two ends that one end is hooked by the hook and the other end is mounted on the mounting protrusion.
